(19) United States
(12) Patent Application Publication
(10) Pub. No.: US 2018/0375230 A1
(43) Pub. Date: Dec. 27, 2018

(54) A GROUNDING ATTACHMENT AND A POLE PROVIDED WITH SUCH A GROUNDING ATTACHMENT

(71) Applicant: Northcone AB, Johanneshov (SE)

(72) Inventor: Lars JOHANSSON, Saltsjö-Boo (SE)

(21) Appl. No.: 15/777,948

(22) PCT Filed: Nov. 11, 2016
(86) PCT No.: PCT/SE2016/051107

§ 371 Date: May 22, 2018

(30) Foreign Application Priority Data
Nov. 24, 2015 (SE) 1551529-9

(51) Int. Cl. H01R 4/64; H01R 4/06

(52) U.S. Cl. CPC H01R 4/643; H01R 4/06

(57) ABSTRACT

A grounding attachment for grounding an outer wall of a pole (13) made of a metal sheet covered on both sides by a coating layer of an electrically insulating material comprises a base element (1) of metal configured to be applied to bear on an inner wall of a pole in a state of use of the grounding attachment and at least one member (8, 9) of metal projecting from the base element and configured to be introduced into a hole in a wall of a pole in the state of use and to bear onto portions of the metal sheet defining the hole so as to establish an electrical contact thereto. The base element is provided with a connector member (4) enabling connection of the base element and by that the pole to ground.

### TECHNICAL FIELD OF THE INVENTION AND BACKGROUND ART

The present invention relates to a grounding attachment for grounding an outer wall of a pole accommodating or arranged in connection with at least one electrical component, such as for lightning purpose, and made of a metal sheet covered on both sides by a coating layer of an electrically insulating material, as well as a pole according to the preamble of the appended claim directed to a pole.

The invention is directed to provide grounding of an outer wall of a pole of any conceivable type as long as it is made of a metal sheet covered on both sides by a coating layer of an electrically insulating material and accommodates or is arranged in connection with at least on electrical component, which means that there is an inherent risk that the metal sheet of the pole may be current carrying due to any malfunction, wear or the like of a said electrical component or cables or the like carrying current. It is then for safety reason important that the outer wall of such a pole is properly grounded for avoiding occurrence of injures of humans which may touch said wall carrying current.

“At least one electrical component” is to be interpreted broadly and covers every type of component arranged in the pole or in connection therewith, such as for illuminating or any outer purpose resulting in conduction of electricity in connection with the pole. Examples of such electrical components are a lamp of a light post and an electrical sign carried by a pole.

In case a said pole is made of a metal sheet having the inner wall thereof of metal it has been possible to provide grounding of the outer wall of the pole by securing a metal base element of a grounding attachment to the inner wall of the pole by welding and providing this base element with a connector member for connection of the base element and by that the pole to ground.

However, such a grounding attachment may not be used in case the inner wall of the metal sheet of which a pole is made is covered by a coating layer of an electrically insulating material, such as a paint or lacquer.

### SUMMARY OF THE INVENTION

The object of the present invention is to provide a grounding attachment enabling a grounding of an outer wall of a pole made of a metal sheet covered on both sides by a coating layer of an electrically insulating material in a simple and reliable way.

This object is according to the invention obtained by providing such a grounding attachment with a base element of metal configured to be applied to bear on an inner wall of a said pole in a state of use of the grounding attachment, and at least one member of metal projecting from the base element and configured to be introduced into a hole in a wall of a said pole in said state of use and to bear onto portions of the metal sheet defining the holes so as to establish an electrical contact thereto, and by providing the base element with a connector member configured to enable connection of the base element and by that the pole to ground.

Thus, the hole in the wall of a pole made of a metal sheet covered on both sides by a coating layer of an electrically insulating material will expose metal sheet portions for efficient contact making by said projecting metal member and by that the wall of the pole to said connector member for connecting it to ground.

According to an embodiment of the invention the projecting metal member is formed by material portions of the base element flared out. This constitutes a simple and by that cost efficient way of creating said projecting metal member for contact of the base element to the metal sheet of the pole wall.

According to another embodiment of the invention the grounding attachment comprises a member configured to be inserted into said projecting member flared out for urging outer portions of the projecting member against the metal sheet portions defining said hole. The existence of such an urging member contributes to the reliability and robustness of the contact making of the projecting metal member to the metal sheet of the pole wall.

According to another embodiment of the invention said projecting metal member is configured to be introduced into a through-hole of a pole and the urging member is configured to be introduced from the outside of the pole into a hole of said projecting member formed by the flaring out. This makes it possible to easily obtain the desired function of said urging member from the outside of the pole, and when according to another embodiment of the invention said urging member is configured to secure the base element to a pole wall once introduced into the projecting metal member securing of the base element to the pole wall may efficiently and easily be carried out from the outside of the pole.

According to another embodiment of the invention said urging member is a rivet. Introducing a rivet into the hole of the projecting member flared out will enable reliable contact making of the projecting metal member and securing of the base element of the grounding attachment to the pole by riveting.

According to another embodiment of the invention said projecting metal member is conical with a cross-section tapering in the direction away from the base element. Such a cross-section facilitates the introduction of the projecting metal member in a hole in a pole wall and this shape is preferably combined with the arrangement of a said urging member for urging outer portions of the projecting member against the metal sheet portions defining a said hole after introducing the projecting metal member into the hole.

According to another embodiment of the invention the projecting metal member is provided with slits cut in surrounding walls thereof. Such slits will increase the flexibility of a projecting metal member and by that facilitate expansion of the flared out portions forming this member to enter into contact with the metal sheet portions defining the hole in a pole wall.

According to another embodiment of the invention said connecting member is arranged on a second part of the base element bent away from a first part of the base element configured to be applied to bear on an inner wall of a pole so as to separate the connector member from an internal wall of the pole in said state of use. This is favourable for easy connection of the connector member to the ground by suitable means for attaching a ground cable or the like.

According to another embodiment of the invention the grounding attachment comprises at least two said members of metal projecting from the base element and configured to be introduced into a hole each in a said pole wall. The presence of more than one such projecting member increases the reliability of the grounding action provided by the grounding attachment and does also opens up for easy obtaining of a fix and reliable securing of the grounding attachment to a pole wall.

According to another embodiment of the invention said base element is provided with a hole with an inner thread and the grounding attachment comprises a screw to be introduced into the threaded hole through a hole in a pole wall and be tightened for securing a lid covering an opening in the pole wall to the pole. This means that the grounding attachment will also assist in providing means for securing a lid covering an opening in the pole wall for access of the interior of the pole for example carrying out maintenance work on the pole.

According to another embodiment of the invention the grounding attachment is configured to ground an outer wall of a pole made by a metal sheet covered on both sides by a decorative layer of paint or lacquer, such as a PRELAQ (trademark) sheet.

The present invention relates also to a pole according to the appended claims directed thereto.

Further advantages as well as advantageous features of the invention will appear from the description following below.

### BRIEF DESCRIPTION OF THE DRAWINGS

With reference to the appended drawings, below follows a specific description of an embodiment of the invention cited as an example.

In the drawings:

FIGS. 1 and 2 are perspective views of a base element of a grounding attachment according to an embodiment of the present invention,

FIG. 3 is a sectioned view of a part of a pole to which a grounding attachment according to said embodiment of the invention is attached, and

FIG. 4 is a perspective view showing the grounding attachment according to the present invention secured to a pole with a lid covering an opening in the pole wall removed.

### DETAILED DESCRIPTION OF AN EMBODIMENT OF THE INVENTION

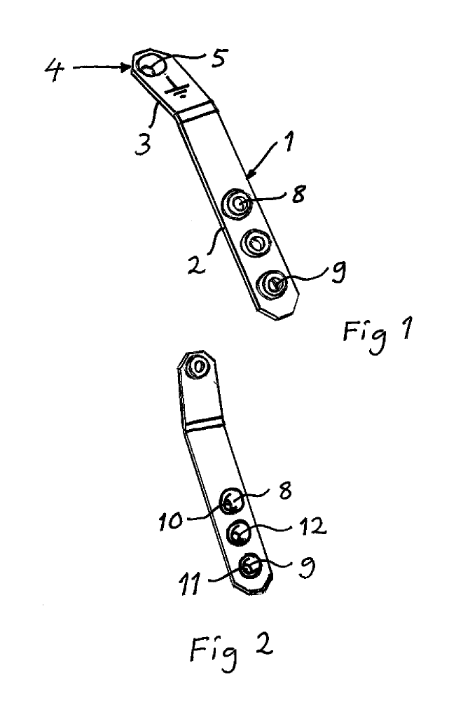

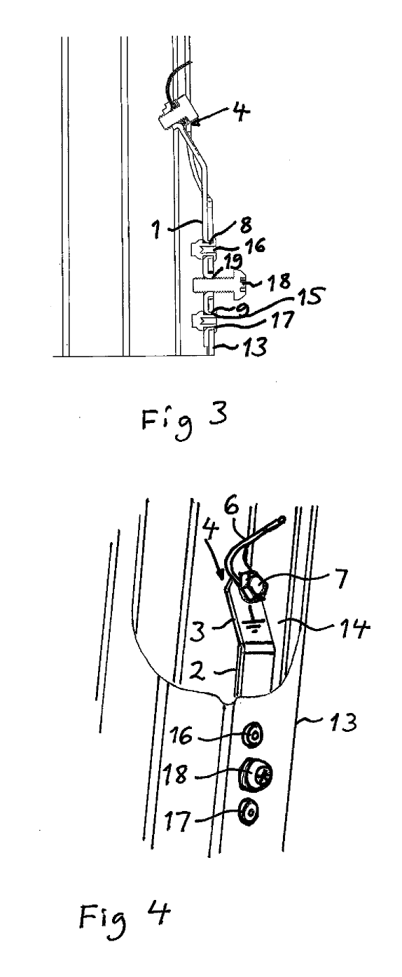

A grounding attachment for grounding an outer wall of a pole according to an embodiment of the invention will now be described while making reference simultaneously to FIGS. 1-4. The grounding attachment has a base element 1 of metal, i.e. a material being a good conductor of electricity, such as steel or any other metal material, and is shown alone in FIGS. 1 and 2. This base element 1 is plate-like and has a first part 2 configured to be applied to bear on an inner wall of a pole in a state of use of the grounding attachment and a second part 3 bent away from the first part so as to separate a connector member 4 configured to enable connection of the base element to ground from an internal wall of the pole in said state of use. The connector member 4 comprises a threaded hole 5 made in the second part 3 of the base element and intended to enable attachment of a ground clamp 6 through a screw 7 for connection thereof to a ground wire (see FIG. 4).

The first part 2 of the base element 1 has two members 8, 9 projecting therefrom and formed by material portions of the base element flared out so that these members are provided with a hole 10, 11. The projecting members 8, 9 are conical with a cross-section tapering in the direction away from the first part 2 of the base element. The first part 2 of the base element is also provided with a hole 12 with an inner thread.

The grounding attachment is intended to be connected to a pole 13 made of a metal sheet covered on both sides by a coating layer of an electrically insulating material through removal of a lid covering an opening 14 (see FIG. 4) in the wall of the pole. The pole is of the type accommodating or arranged in connection with at least one electrical component, such as for lightning purpose. The base element is moved while introducing the projecting members 8, 9 into a respective through-hole 15 in the wall of the pole 13 so that the first part 2 of the base element 1 will be applied to bear on an inner wall of the pole. Rivets 16, 17 will then be introduced from the outside of the pole into the holes 10, 11 of the projecting members 8, 9 so as to urge outer portions of the projecting members against metal sheet portions defining the respective through-hole 15 and then also secure the base element to the pole wall by riveting. A grounding wire not shown may then be connected to the ground clamp 6 of the connector member 4 for grounding the pole wall by the contact made by said outer portions of the projecting members 8, 9 with the metal sheet portions defining the through-hole 15. A lid not shown may then be secured through a screw 18 introduced into the threaded hole 12 in the base element through a further hole 19 in the pole wall for covering the opening 14.

The invention is of course not in any way restricted to the embodiment just described, but many possibilities to modifications thereof would be apparent to a person with skill in the art without for that sake departing from the scope of the invention as defined in the appended claims.

The projecting members may be provided with slits in the walls surrounding the opening thereof for making them more flexible and easier to expand and urge by an urging member, such as a rivet, to bear tightly against metal sheet portions defining a hole in a pole wall.

The presence of only one said projecting member is also possible for obtaining a reliable grounding function of the grounding attachment, although two or more such projecting members facilitates proper securing of the grounding attachment to the pole.

The projecting member has not to be formed by material portions of the base element flared out, although this is very advantageous, but it may be formed by a separate member of metal secured to the base element, such as by welding or even by engagement of threads or the like.

1. A grounding attachment for grounding an outer wall of a pole accommodating or arranged in connection with at least one electrical component, such as for lightning purpose, and made of a metal sheet covered on both sides by a coating layer of an electrically insulating material, comprising:
a base element (1) of metal configured to be applied to bear on an inner wall of the pole in a state of use of the grounding attachment, and
at least one member (8, 9) of metal projecting from the base element and configured to be introduced into a hole (15) in a wall of the pole in said state of use and bear onto portions of the metal sheet defining the hole to establish an electrical contact thereto, and
the base element (1) is provided with a connector member (4) configured to enable connection of the base element and the pole to ground.

2. A grounding attachment according to claim 1, wherein said projecting metal member (8, 9) is formed by material portions of the base element (1) flared out.

3. A grounding attachment according to claim 2, comprising a member (16, 17) configured to be inserted into said projecting member flared out for urging outer portions of the projecting member against said metal sheet portions defining said hole (15).

4. A grounding attachment according to claim 3, wherein said projecting metal member (8, 9) is configured to be introduced into the through-hole (15) of pole and the urging member (16, 17) is configured to be introduced from the outside of the pole into a hole (10, 11) of said projecting member formed by the flaring out.

5. A grounding attachment according to claim 3, wherein said urging member (16, 17) is configured to secure the base element (1) to the pole wall once introduced into the projecting metal member (8, 9).

6. A grounding attachment according to claim 4, wherein said urging member is a rivet (16, 17).

7. A grounding attachment according to claim 2, wherein said projecting metal member (8, 9) is conical with a cross-section tapering in the direction away from the base element (1).

8. A grounding attachment according to claim 2, wherein slits are cut in surrounding walls defining said projecting metal member.

9. A grounding attachment according to claim 1, wherein said connector member (4) is arranged on a second part (3) of the base element (1) bent away from a first part (2) of the base element configured to be applied to bear on an inner wall of a pole to separate the connector member from an internal wall of the pole in said state of use.

10. A grounding attachment according to claim 1, comprising at least two said members (8, 9) of metal projecting from the base element (1) and configured to be introduced into a respective hole (15) each in said pole wall.

11. A grounding attachment according to claim 1, wherein said base element (1) is provided with a hole (12) with an inner thread and the grounding attachment comprises a screw (18) to be introduced into the threaded hole through the hole (19) in the pole wall and be tightened for securing a lid covering an opening (14) in the pole wall to the pole.

12. A grounding attachment according to claim 1, configured to ground an outer wall of the pole made by a metal sheet covered on both sides by a decorative layer of paint or lacquer, such as a PRELAQ (trademark) sheet.

13. A pole accommodating or arranged in connection with at least one electrical component and made of a metal sheet covered on both sides by a coating layer of an electrically insulating material, and provided with a grounding attachment according to claim 1 configured to ground an outer wall of the pole.

14. A pole according to claim 13, which is a light post.

15. A grounding attachment according to claim 4, wherein said urging member (16, 17) is configured to secure the base element (1) to the pole wall once introduced into the projecting metal member (8, 9).

16. A grounding attachment according to claim 15, wherein said urging member is a rivet (16, 17).

17. A grounding attachment according to claim 5, wherein said urging member is a rivet (16, 17).

18. A grounding attachment according to claim 17, wherein said projecting metal member (8, 9) is conical with a cross-section tapering in the direction away from the base element (1).

19. A grounding attachment according to claim 16, wherein said projecting metal member (8, 9) is conical with a cross-section tapering in the direction away from the base element (1).

20. A grounding attachment according to claim 15, wherein said projecting metal member (8, 9) is conical with a cross-section tapering in the direction away from the base element (1).
